(19) United States
(12) Patent Application Publication
(10) Pub. No.: US 2007/0266199 A1
(43) Pub. Date: Nov. 15, 2007

(54) Virtual Address Cache and Method for Sharing Data Stored in a Virtual Address Cache

(75) Inventors: Itay Peled, Beer-sheva (IL); Moshe Anschel, Kfar Saba (IL); Moshe Bachar, Tel Aviv (IL); Jacob Efrat, Kfar Saba (IL); Alon Eldar, Ra'anana (IL); Yakov Tokar, Asdod (IL)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: Freescale Semiconductor, Inc., Austin, TX (US)

(21) Appl. No.: 11/574,864

(22) PCT Filed: Sep. 7, 2004
(86) PCT No.: PCT/IB04/52943

§ 371 Date: Mar. 7, 2007

(51) Int. Cl. G06F 12/00

(52) U.S. Cl. 711/6; 711/3

(57) ABSTRACT

A virtual address cache comprising a comparator arranged to receive a virtual address for addressing data associated with a task and a memory, wherein the comparator is arranged to make a determination as to whether data associated with the received virtual address is stored in the memory based upon an indication that the virtual address is associated with data shared between a first task and a second task and a comparison of the received virtual address with an address associated with data stored in memory.

### FIELD OF THE INVENTION

The present invention relates to a virtual address cache and a method for sharing data stored in a virtual address cache.

### BACKGROUND OF THE INVENTION

Digital data processing systems are used in many applications including for example consumer electronics, computers, cars, etc. For example, personal computers (PCs) use complex digital processing functionality to provide a platform for a wide variety of user applications.

Digital data processing systems typically comprise input/output functionality, instruction and data memory and one or more data processors, such as a microcontroller, a microprocessor or a digital signal processor.

An important parameter of the performance of a processing system is the memory performance. For optimum performance, it is desired that the memory is large, fast and preferably cheap. Unfortunately these characteristics tend to be conflicting requirements and a suitable trade-off is required when designing a digital system.

In order to improve memory performance of processing systems, complex memory structures which seek to exploit the individual advantages of different types of memory have been developed. In particular, it has become common to use fast cache memory in association with larger, slower and cheaper main memory.

For example, in a PC the memory is organised in a memory hierarchy comprising memory of typically different size and speed. Thus a PC may typically comprise a large, low cost but slow main memory and in addition have one or more cache memory levels comprising relatively small and expensive but fast memory. During operation data from the main memory is dynamically copied into the cache memory to allow fast read cycles. Similarly, data may be written to the cache memory rather than the main memory thereby allowing for fast write cycles.

Thus, the cache memory is dynamically associated with different memory locations of the main memory and it is clear that the interface and interaction between the main memory and the cache memory is critical for acceptable performance. Accordingly significant research into cache operation has been carried out and various methods and algorithms for controlling when data is written to or read from the cache memory rather than the main memory as well as when data is transferred between the cache memory and the main memory have been developed.

Typically, whenever a processor performs a read operation, the cache memory system first checks if the corresponding main memory address is currently associated with the cache. If the cache memory contains a valid data value for the main memory address, this data value is put on the data bus of the system by the cache and the read cycle executes without any wait cycles. However, if the cache memory does not contain a valid data value for the main memory address, a main memory read cycle is executed and the data is retrieved from the main memory. Typically the main memory read cycle includes one or more wait states thereby slowing down the process.

A memory operation where the processor can receive the data from the cache memory is typically referred to as a cache hit and a memory operation where the processor cannot receive the data from the cache memory is typically referred to as a cache miss. Typically, a cache miss does not only result in the processor retrieving data from the main memory but also results in a number of data transfers between the main memory and the cache. For example, if a given address is accessed resulting in a cache miss, the subsequent memory locations may be transferred to the cache memory. As processors frequently access consecutive memory locations, the probability of the cache memory comprising the desired data thereby typically increases.

To improve the hit rate of a cache N-way caches are used in which instructions and/or data is stored in one of N storage blocks (i.e. ‘ways’).

Cache memory systems are typically divided into cache lines which correspond to the resolution of a cache memory. In cache systems known as set-associative cache systems, a number of cache lines are grouped together in different sets wherein each set corresponds to a fixed mapping to the lower data bits of the main memory addresses. The extreme case of each cache line forming a set is known as a direct mapped cache and results in each main memory address being mapped to one specific cache line. The other extreme where all cache lines belong to a single set is known as a fully associative cache and this allows each cache line to be mapped to any main memory location.

In order to keep track of which main memory address (if any) each cache line is associated with, the cache memory system typically comprises a data array which for each cache line holds data indicating the current mapping between that line and the main memory. In particular, the data array typically comprises higher data bits of the associated main memory address. This information is typically known as a tag and the data array is known as a tag-array. Additionally, for larger cache memories a subset of an address (i.e. an index) is used to designate a line position within the cache where the most significant bits of the address (i.e. the tag) is stored along with the data. In a cache in which indexing is used an item with a particular address can be placed only within a set of lines designated by the relevant index.

To allow a processor to read and write data to memory the processor will typically produce a virtual address. A physical address is an address of main (i.e. higher level) memory, associated with the virtual address that is generated by the processor. A multi-task environment is an environment in which the processor may serve different tasks at different times. Within a multi-task environment, the same virtual addresses, generated by different tasks, is not necessarily associated with the same physical address. Data that is shared between different tasks is stored in the same physical location for all the tasks sharing this data; data not shared between different tasks (i.e. private data) will be stored in a physical location that is unique to its task. This is more clearly illustrated in FIG. 1, where the y-axis defines virtual address space and the x-axis defines time. The private data 150 associated with the four tasks 151, 152, 153, 154, as shown in FIG. 1, are arranged to have the same virtual addresses however the associated data stored in external memory will be stored in different physical addresses. The shared data 155 of the four tasks 151, 152, 153, 154 are arranged to have the same virtual addresses and the same physical addresses.

Consequently, a virtual address cache will store data with reference to a virtual address generated by a processor; data to be stored in external memory is stored in physical address space.

Further, a virtual address cache operating in a multi-tasking environment will have an address or tag field, for storing an address/tag associated with stored data and a task identifier ID field for identifying as to which task the address/tag and data are associated.

Consequently, within a multi-tasking environment a ‘hit’ requires that the address/tag for data stored in the cache matches the virtual address requested by the processor and the task-id field associated with data stored in cache matches the current active task being executed by the processor.

When a processor switches from one task to another task the contents of a virtual address data cache, associated with the first task, will typically be flushed to a higher level memory and new data associated with the new task is loaded in to the virtual address cache. This enables the new task to use updated data that is shared between the two tasks. However, the need to change the memory contents when switching between tasks increases the bus traffic between the cache and the higher level memory, and increases the complexity of the operating system in the handling of inter-process communication. This may also produce redundant time consuming ‘miss’ accesses to shared data after the flush. In case of shared code, the flush is not needed after the task switch. However, this increases the footprint of shared code by needing to duplicate the shared code in the cache memory.

One solution has been to use a physical address cache where a translator translates the virtual address generated by a processor into a respective physical address that is used to store the data in the physical address cache, thereby ensuring that data shared between tasks is easily identified by its physical address.

However, the translation of the virtual address to its corresponding physical address can be difficult to implement in high-speed processors that have tight timing constraints.

It is desirable to improve this situation.

### STATEMENT OF INVENTION

The present invention provides a virtual address cache and a method for sharing data stored in a virtual address cache as described in the accompanying claims.

This provides the advantage of allowing a virtual address cache to share data and code between different tasks within a multi-task environment without the need to flush the cache data to a higher level when switching between the different tasks, thereby minimising bus traffic between the cache and the higher level memory; reduce complexity of the operating system in the handling of inter-process communication; reduce the number of time consuming ‘miss’ accesses to shared data after the flush; and reduce the footprint of shared code by not needing to duplicate the shared code in the cache memory.

### BRIEF DESCRIPTION OF THE DRAWINGS

The present invention will now be described, by way of example, with reference to the accompanying drawings, in which:

FIG. 1 illustrates a virtual address space versus time chart;

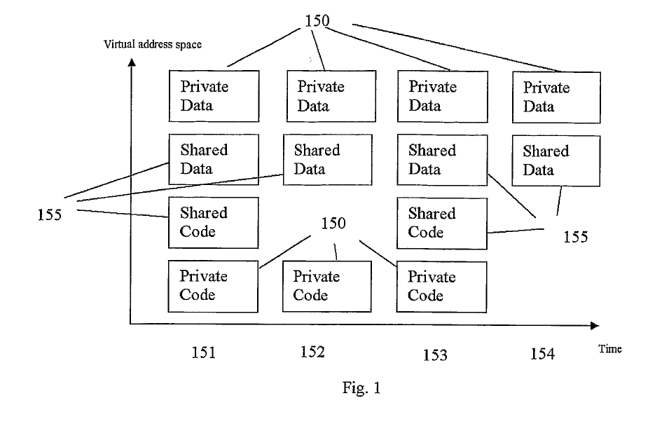

FIG. 2 illustrates a cache system according to an embodiment of the present invention;

FIG. 3 illustrates a data cache according to an embodiment of the present invention;

FIG. 4 illustrates a comparator arrangement according to an embodiment of the present invention.

### DESCRIPTION OF A PREFERRED EMBODIMENT

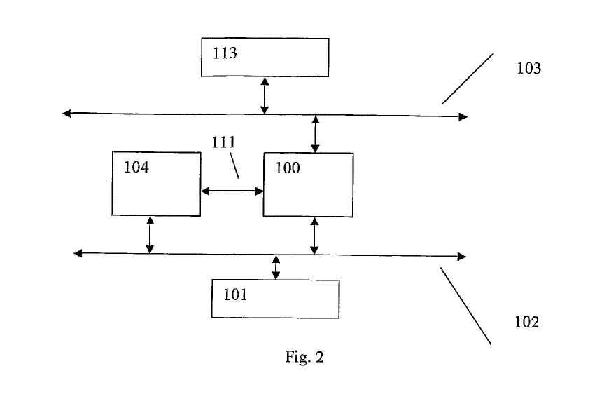

FIG. 2 shows a virtual address cache 100 in which the virtual address cache 100 is able to make a determination as to whether a virtual address match exists between a received virtual address generated by a processor 101 and data associated with a virtual address stored in cache memory within the virtual address cache 100, where if a shared data indicator is provided a task-ID match is not required. This allows shared data to be retained and used in the virtual address cache 100 between different tasks executed by the processor 101. However, if a shared data indicator is not provided (i.e. to indicate private data) a task-ID match is required in addition to a virtual address match.

FIG. 2 shows a virtual address data cache 100 and a memory controller 104 coupled to a system processor 101 via a parallel processor bus 102 with the virtual address data cache 100 additionally being coupled to system memory 113 (i.e. external memory) via a parallel system bus 103. It should be noted, however, that although this embodiment refers to a virtual address data cache the embodiment could equally apply to a virtual address instruction cache.

The virtual address data cache 100 is arranged to store data with reference to virtual addresses generated by the system processor 101.

The memory controller 104 is coupled to the data cache 100 via a parallel bus 111.

The memory controller 104 is arranged to control external memory access and translate virtual addresses to physical addresses.

The memory controller 104 is arranged to implement a high speed translation mechanism that translates from virtual to physical addresses in order to support memory relocation.

Additionally, the memory controller 104 provides cache and bus control for memory management.

The memory controller 104 is arranged to store task ID information to support multi-task cache memory management to allow identification of shared and private tasks, as described below.

Although the current embodiment shows the virtual address data cache 100 being coupled to the system processor 101 via a parallel bus the virtual address data cache 100 can be physically integrated within a processor.

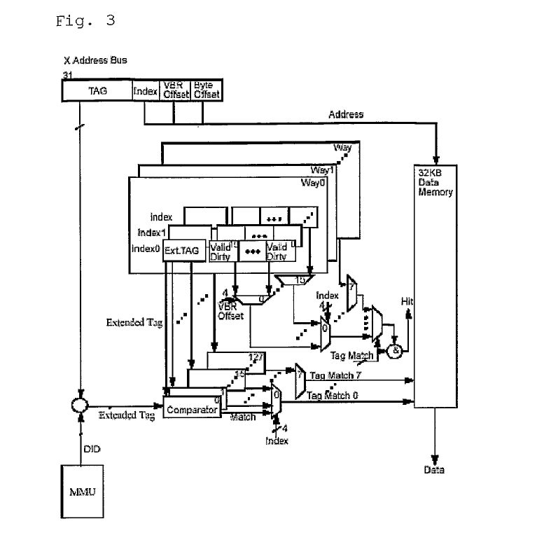

FIG. 3 shows the virtual address data cache 100 having a first input 301 for receiving a virtual address from the processor 101 via the processor bus 102 and a second input 302 for receiving a task-ID from the memory controller 104. The received virtual address is associated with data that the processor 101 needs for the execution of one of a plurality of tasks. The task-ID is used to identify the actual task that the processor is executing for which the data associated with the virtual address is required.

Within this embodiment the memory controller 104 is able to distinguish between 255 different tasks, however, a different number of tasks may be supported.

Although the current embodiment shows the task-ID being provided by the memory controller 104 the virtual address data cache 100 could receive the task-ID from other elements within a computing system, for example the processor 101.

The virtual address data cache 100 includes a first summing node 303, a second summing node 304, a series of comparators 305 (i.e. a plurality of comparators), cache memory 306, an N-way memory block 307 that includes tag memory 308 and valid bit memory 309, and a valid bit checker module 310.

The first summing node 303 is coupled to the first input 301 and the second input 302 for receiving the tag portion of the virtual address from the processor 101 and the task-ID from the memory controller 104. The first summing node 303 combines the received tag and task-ID to produce an extended tag that is input to a first input on each one of the series of comparators 305.

The N-way memory block 307 uses an indexing system, as described above, for allowing memory addressing. As such, in addition to the virtual address generated by the processor 101 having a tag field the virtual address also includes an index field, as described above, and as is well known to a person skilled in the art. However, other addressing format could be used.

The N-way memory block 307, which is used to define the status and location of all data stored in cache memory 306, includes N memory blocks with each block having a plurality of indexes, for example 16, where each index includes an extended tag field 308 and a plurality of valid bit fields that form the valid bit memory 309. The extended tag field 308 includes a task-ID and a tag address for a given index, which allows an access to be mapped to a cache line in cache memory 306 where a cache line is defined by a combination of cache way and index. The plurality of valid bit resolution fields 309 includes status information as to whether corresponding data bits within a cache line to which the access is mapped are valid or dirty, as is well known to a person skilled in the art.

The N-way memory block 307 is coupled to a second input on each of the series of comparators 305 such that each index in the N-way memory block 307 is coupled to an associated comparator. Accordingly, the number of comparators 305 is equal to the number of index fields in the N-way memory block 307. However, the use of multiplexers could be used to reduce the number of required comparators.

Additionally, the N-way memory block 307 is arranged to input the extended tag information for each index into the comparator 305 associated with the respective index.

A control line 311 from the memory controller 104 is coupled to a third input on each of the series of comparators 305 where the memory controller 104 is arranged to generate a control signal to indicate whether a virtual address generated by the processor 101 is associated with shared data (i.e. data to be shared between tasks) or private data (i.e. data specific to a single task). The control signal could be any pre-arranged signal.

Within this embodiment the memory controller 104 determines whether a virtual address generated by the processor 101 corresponds to shared or private data based upon whether the generated virtual address is within a predetermined range of addresses, where one range of virtual addresses correspond to shared data and another range of virtual addresses correspond to private data. However, other means for determining whether a virtual address corresponds to share or private data could be used, for example a control signal from the processor 101 directly or the virtual address cache 100 could be pre-programmed with a range of virtual address spaces that correspond to shared or private data.

The N-way memory block 307 is additionally coupled to the valid bit checker module 310 to allow the valid bit checker to monitor the status of each of the valid bit fields for each index in the N-way memory block 307 to allow the valid bit checker module 310 to determine whether any given bit stored in cache memory 306 is valid or dirty.

The cache memory 306 has a first input coupled to the first input 301 of the virtual address data cache 100 for receiving index information included within the virtual address generated by the processor to allow an association to be made between the access and the relevant cache line.

The cache memory 306 has a second input coupled to the outputs from the comparators 305 in which the individual comparators are each associated with a cache line in cache memory.

The cache memory 306 has a first output for exchanging data between the processor 101 and system memory 113 over the processor bus 102 and system bus 103 respectively.

The series of comparators 305 are arranged to make a determination as to whether there is a match between a virtual address that is associated with data within the cache memory 306 and the virtual address generated by the processor 101, as described below.

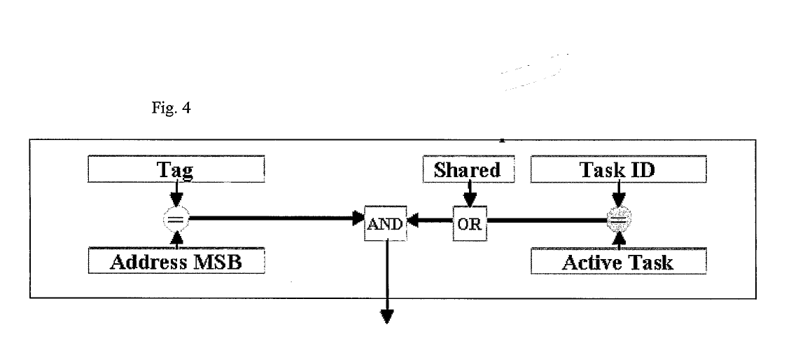

FIG. 4 illustrates the individual components of a comparator 400. The comparator 400 includes a first comparator element 401, a second comparator element 402, an OR gate 403 and an AND gate 404.

The first comparator element 401 is coupled to both the first summing node 303 for receiving tag information for a virtual address generated by the processor 101 and to the N-way memory block 307 for receiving tag information for data stored in cache memory 306 to allow a comparison to be made between tag information for a virtual address generated by the processor 101 and tag information associated with data stored in a cache line, in cache memory 306, to which the comparator 400 is associated.

The second comparator element 402 is coupled to both the first summing node 303 for receiving task-ID information provided by the memory controller 104 and to the N-way memory block 307 for receiving task-ID information for data stored in cache memory 306 to allow a comparison to be made between task-ID information for a virtual address generated by the processor 101 and task-ID information associated with data stored in a cache line, in cache memory, to which the comparator 400 is associated.

The OR gate 403 is coupled to the output of the second comparator element 402 and the memory controller control signal 311 for performing an OR operation on the outputs from the second comparator element 402 and the memory controller control signal 311.

The AND gate 404 is coupled to the output of the first comparator element 401 and the output from the OR gate 403.

Accordingly, the comparator 400 is arranged to provide a positive output match between the received virtual address generated by the processor 101 and the virtual address of data in a cache line, in cache memory 306, if the first comparator element 401 identifies that the virtual address tag generated by the processor 101 is the same as the tag information stored in the extended tag 308 of the N-way block 307 to which the comparator 400 is associated and either the memory controller control signal 311 is set to indicates that data associated with the virtual address is shared (i.e. more than one task may use the data) or the task-ID provided by the memory controller 104 is the same as the task-ID associated with the data stored in cache memory 306.

Consequently, data stored in cache memory 306 that is to be shared between different tasks can be retained in cache memory when the processor 101 is switching between different tasks, thereby avoiding the need to flush all cache memory when the processor is switching between different tasks. This allows ‘hit’ accesses to share data, which is already stored in the cache memory, directly after the task switch.

In this embodiment an individual comparator 305 is assigned to each respective extended tag in the N-way block 307. Accordingly, on receipt of a virtual address generated by the processor 101 each of the comparators 305 performs a comparison between the received virtual address and the extended tag 308 of the N-way block 307 to which they are associated.

The output from each of the comparators 305 are coupled to the cache memory, as described above, and to the second summing node 304.

The valid bit checker module 310 is coupled to each of the valid bit resolution fields 309 for determining whether any given bit stored in cache memory is valid or dirty. The output from the valid bit checker module 310 is couple to the second summing node 304 where the second summing node 304 is arranged to generate a ‘hit’ indication to the processor 101 if the valid bit checker module 310 identifies that the bits of a cache line associated with a matched virtual address are valid and the associated comparator 305 for the cache line determines that the virtual address generated by the processor 101 has been designated as either shared data or has a matched task-ID.

If a ‘hit’ condition has been identified then the output from the comparator 305 that identified the match is used to initiate the outputting of the ‘hit’ data from the cache memory 306 to the processor 101.

1. A virtual address cache (100) comprising a memory (306) and a comparator (400) arranged to receive a virtual address for addressing data associated with a task, characterised in that the comparator (400) is arranged to make a determination as to whether data associated with the received virtual address is stored in the memory (306) based upon an indication (311) that the virtual address is associated with data shared between a first task having a first identifier and a second task having a second identifier and a comparison of the received virtual address with an address associated with data stored in memory (306); thereby allowing tasks with different identifiers to have shared data and private data.

2. A virtual address cache (100) according to claim 1, wherein the comparator (400) is arranged to receive a task identifier associated with the received virtual address, wherein the comparator (400) is arranged to make a determination as to whether data associated with the received virtual address is stored in the memory (306) based upon an indication (311) that the virtual address in not associated with shared data and a comparison of the received virtual address with an address associated with data stored in memory (306) and a comparison of the received task identifier with a task associated with data stored in memory (306).

3. A virtual address cache (100) according to claim 1 or 2, wherein the indication that the virtual address is associated with data shared between the first task and a second task is provided by a control signal (311) to the comparator (400).

4. A virtual address cache (100) according to claim 3, further comprising a memory controller (104) arranged to generate the control signal (311) upon a determination that a virtual address is associated with data shared between the first task and a second task

5. A virtual address cache (100) according to any preceding claim, wherein the address associated with data stored in memory (306) corresponds to a tag.

6. A virtual address cache (100) according to any preceding claim, wherein the part of the bits of a received virtual address are used in the comparison of the received virtual address with an address associated with data stored in memory (306).

7. A method for sharing data stored in a virtual address cache (100), the method comprising receiving a virtual address for addressing data associated with a task; characterised by determining as to whether data associated with the received virtual address is stored in a memory (306) based upon an indication that the virtual address is associated with data shared between a first task having a first identifier and a second task having a second identifier and a comparison of the received virtual address with an address associated with data stored in memory (306); thereby allowing tasks with different identifiers to have shared data and private data.

8. A method for sharing data stored in a virtual address cache according to claim 7, further comprising receiving a task identifier associated with the received virtual address; and determining as to whether data associated with the received virtual address is stored in the memory (306) based upon an indication that the virtual address in not associated with shared data and a comparison of the received virtual address with an address associated with data stored in memory (306) and a comparison of the received task identifier with a task associated with data stored in memory (306).

9. A Computer Apparatus comprising data processing means, a main memory and a cache operably coupled to share data as claimed in any preceding claim.
